(19) United States
(12) Patent Application Publication
(10) Pub. No.: US 2007/0159828 A1
(43) Pub. Date: Jul. 12, 2007

(54) Vertical LED lamp with a 360-degree radiation and a high cooling efficiency

(75) Inventor: Robert Wang, Taoyuan (TW)

Correspondence Address: BRUCE H. TROXELL, SUITE 1404, 5205 LEESBURG PIKE, FALLS CHURCH, VA, 22041, US

(73) Assignee: Ceramate Technical Co., Ltd.

(21) Appl. No.: 11/327,477

(22) Filed: Jan. 9, 2006

(51) Int. Cl. F21V 29/00

(52) U.S. Cl. 362/294

(57) ABSTRACT

A vertical LED lamp with a 360-degree radiation and a high cooling efficiency includes a lampshade, a lamp base and a LED module. The LED module is contained in a chamber surrounded by the lampshade and the lamp base. The lamp base is able to provide DC for the LED module to work. The LED module is composed of a cooling column and a preset number of LED boards. The cooling column, shaped as a triangle or a tetragon or polygon and made of a thermal conductive material, is provided with a plugging slot on each surface for fitting with the LED bulb board, and plural fins formed on each surface for increasing areas to contact air Therefore, the LED lamp has 360-defree radiation and can perform with a better brightness and obtain a longer life.

### BACKGROUND OF THE INVENTION

1. Field of the Invention

This invention relates to a LED lamp, particularly to one that uses a cooling column to enable a vertical LED lamp have a 360-degree radiation and a high cooling efficiency to generate a brighter light and to work under a lower temperature so as to obtain a much longer life.

2. Description of the Prior Art

Since a light emitting diode (LED) possesses several advantages, such as long life, energy saving and quick response etc., it is therefore widely applied in traffic signals, big advertising billboards, transports, flashlights and indoor lighting, etc. A common conventional LED module always includes a LED bulb board, composed of plural LED chips, and a current circuit able to supply a proper direct current for the LED board to work for shining. But, the LED bulb board is always arranged only on a flat plane so that it cannot provide total brightness in all directions. And, if the LED board is kept working continuously, it will produce incessant heat that is to warm the circumferential temperature of the LED board to weaken the brightness, and the epoxy resin wrapped outside the LED expands excessively to make its wirings shift, causing an interruption for the LED and a short life for the LED module.

### SUMMARY OF THE INVENTION

The prime object of this invention is to offer a vertical LED lamp with a 360-degree radiation and a high cooling efficiency.

The main characteristics of the invention are a lampshade, a lamp base and a LED module. The LED module is contained in a chamber surrounded by the lampshade and the lamp base. The lamp base has a rectifying device for converting AC power into DC for the LED module to work. The LED module is composed of a cooling column and a preset number of LED boards. The cooling column, shaped as a triangle or a tetragon or polygon and made of a thermal conductive material, is provided with a plugging slot on each surface for fitting with an LED board, and plural fins on each surface for increasing areas to contact air. Therefore, the LED lamp can have 360-degree radiation and perform with a better brightness and obtain a longer life.

### BRIEF DESCRIPTION OF DRAWINGS

This invention is better understood by referring to the accompanying drawings, wherein:

FIG. 1 is a perspective view of a preferred embodiment of a vertical LED lamp with a 360-degree radiation and a high cooling efficiency in the present invention;

FIG. 2 is an exploded perspective view of the preferred embodiment of a vertical LED lamp with a 360-degree radiation and a high cooling efficiency in the present invention; and

FIG. 3 is cross-sectioned view of the preferred embodiment of a vertical LED lamp with a 360-degree radiation and a high cooling efficiency in the present invention.

### DETAILED DESCRIPTION OF THE PREFERRED EMBODIMENT

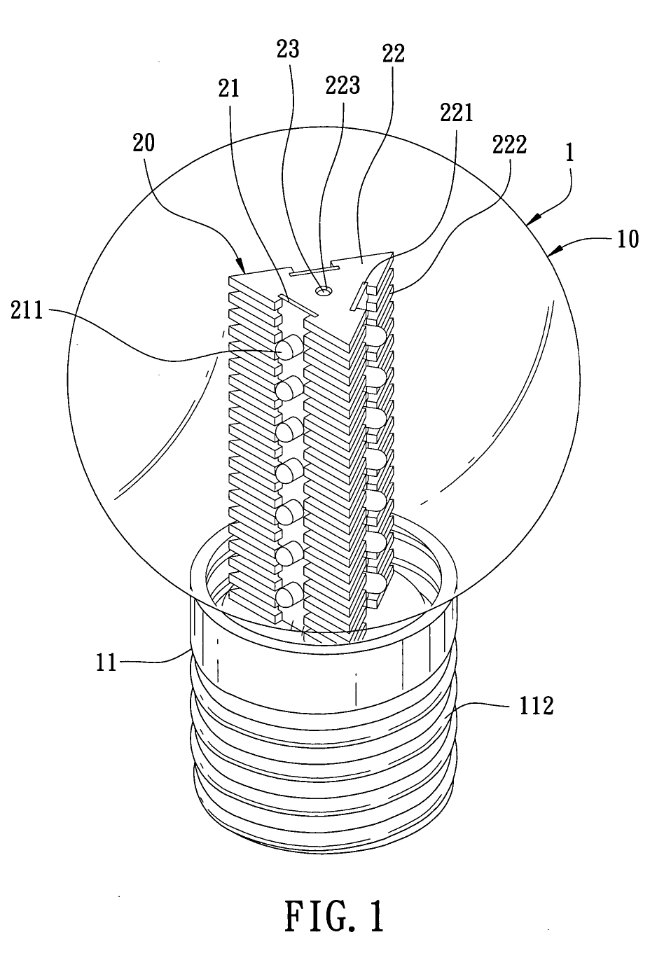

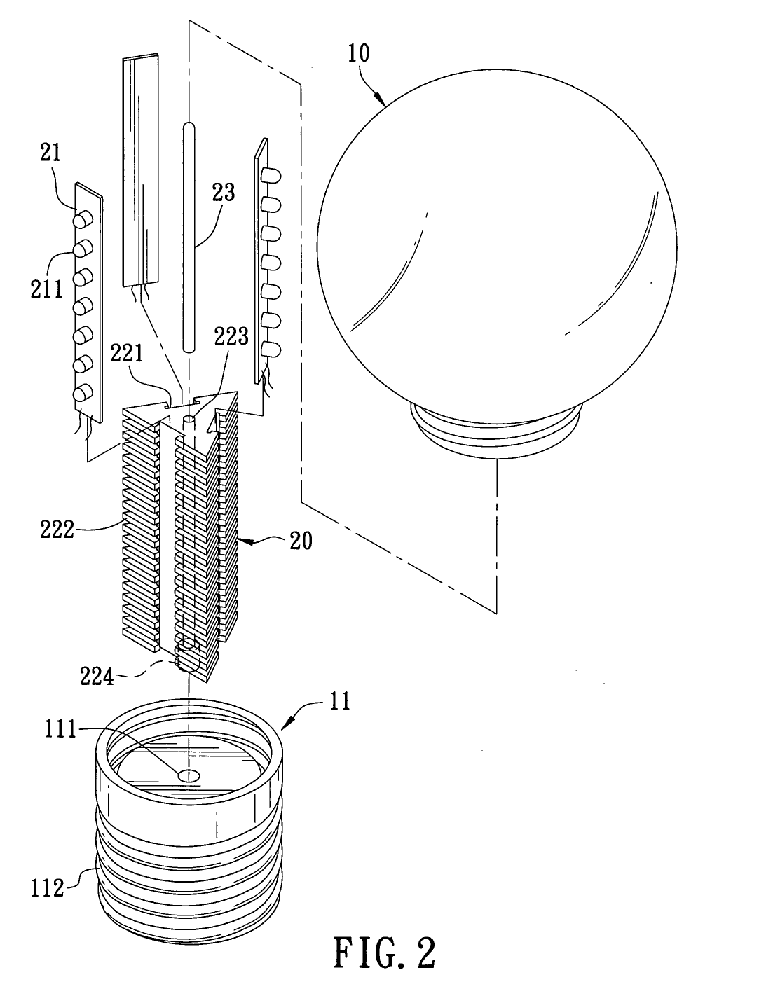

As shown in FIGS. 1 and 2, a preferred embodiment of a vertical LED lamp 1 with a 360-degree radiation and a high cooling efficiency in the present invention includes a lampshade 10, a lamp base 11 and a LED module 20. When the bottom of the lampshade 10 is matched with the lamp base 11, the confined space surrounded by the lampshade 10 and the lamp base 11 is to contain the LED module 20. The lamp base 11 is connected with a power line outside, having a rectifying device for converting AC power into DC for enabling the LED module 20 to work.

The LED module 20 is composed of a preset number of LED boards 21 and a cooling column 22. Each LED board 21 provided with a preset number of LED bulbs 211 is to be in contact with the lamp base 11 able to provide proper DC voltage to enable the LED board 21 to work. The cooling column 22 shaped triangular is made of aluminum and set with a plugging slot 221 on each side surface for fitting with the LED board 21. The rear surface of the LED board 21 contacting with the cooling column 22 is coated with a heat transmitting paste so as to increase contacting area and conductivity. In addition, each side surface of the cooling column 22 is provided with plural fins 222 and, a cooling hole 223 is formed along the central axis of the cooling column 223 for a cooling bar 23 to fit therein. Further, the cooling column 22 has a projecting bar 224 in the bottom that is to be plugged into a recess 111 formed in the lamp base 11 corresponding with the projecting bar 224, enabling the LED module 20 to be fixed together with the lamp base 11. A spiral member 112 formed at the outer surface of the lamp base 11 can be screwed together with a common regular socket without need of making an extra socket.

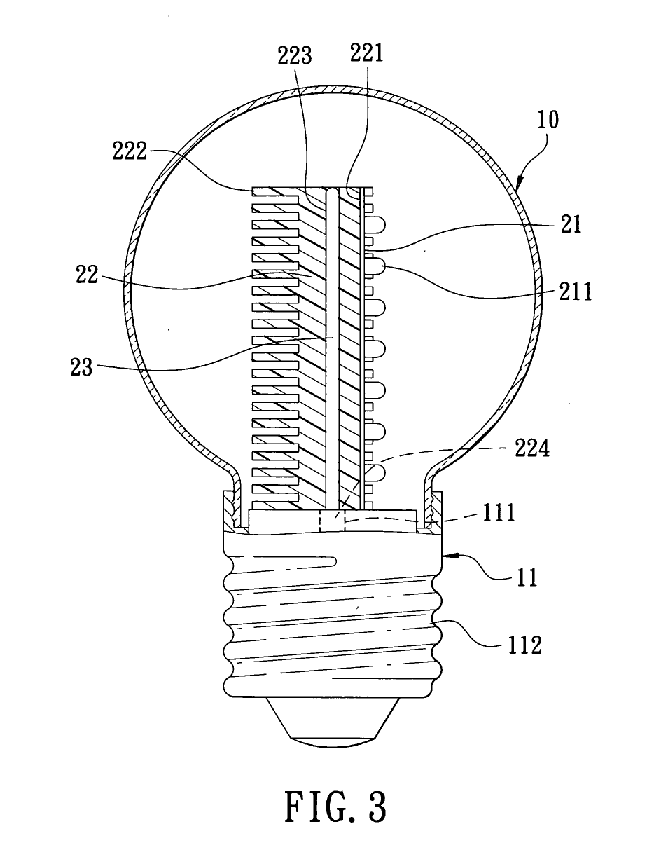

In using, as shown in FIGS. 2 and 3, when the LED module 20 of the lamp 1 is lit up, its circumference starts to get heated. As the cooling column 22 is made of aluminum with a good thermal conductivity and provided with plural fins 222 on each surface and a cooling hollow 223 along its central axis, areas for contacting air is increased, enhancing the heat conductivity. Moreover, The cooling bar 23 plugged in the cooling hollow 223 can as well enhance the heat conductivity. Therefore, the heat produced by the LED board 21 can be quickly dispersed into the air to decrease the temperature of the LED module 20.

The present invention has advantages and the effects described below:

1. The cooling column 22 of the lamp 1 is provided with the plural fins 222 to increase a large surface to contact air for releasing heat so as to decrease the temperature of the LED module 20, resulting in a stable brightness and a longer life for the LED module 20.

2. The length of the cooling column 22 can be changed to get an appropriate number of LEDs for a required brightness.

3. Because the number of the LED is changeable, a composition of plural LED chips with a low power dissipation can promise a higher brightness efficiency and avoid risk of a single chip to be damaged or get out of order, achieving a very long life.

4. The shape of the cooling column 22 is changeable, so it cab be matched with the various designs of the lampshade 10 to obtain a maximum brightness and a much wider space to be shown, different from known products designed in a flat plane (180 degrees) only. Therefore, this invention is emphasized with “360-degree”.

5. The rectifying device set in the lamp base 11 can be a capacitance, a coupled transformer, an IC or a resistance for reducing voltage so as to gain DC for the LEDs.

6. The LED lamp 1 can be used for the conventional socket, providing a popular convenience for usage and reducing cost for manufacturing with no need of making a special socket.

While the preferred embodiment of the invention has been described above, it will be recognized and understood that various modifications may be made therein and the appended claims are intended to cover all such modifications that may fall within the spirit and scope of the invention.

What is claimed is:

1. A vertical LED lamp with a 360-degree radiation and a high cooling efficiency comprising:
a lampshade;
a lamp base combined with said lampshade to surround a LED module and connected with a power line, said lamp base having a rectifying device for converting AC power into DC so as to enable said LED module to work; and
said LED module consisting of a cooling column and a preset number of LED boards, said cooling column shaped as a polygon and made of a thermal conductive material and provided with a plugging slot in each surfaces respectively for fitting with one of said LED boards and plural fins formed on each surface respectively.

2. A vertical LED lamp with a 360-degree radiation and a high cooling efficiency as claimed in claim 1, wherein said cooling column is made of aluminum.

3. A vertical LED lamp with a 360-degree radiation and a high cooling efficiency as claimed in claim 1, wherein said cooling column is set with a cooling hole in its central axis.

4. A vertical LED lamp with a 360-degree radiation and a high cooling efficiency as claimed in claim 1, wherein said cooling column is shaped triangular.

5. A vertical LED lamp with a 360-degree radiation and a high cooling efficiency as claimed in claim 3, wherein said cooling hole is fitted with a cooling bar.
